(19) United States
(12) Patent Application Publication
(10) Pub. No.: US 2005/0223144 A1
(43) Pub. Date: Oct. 6, 2005

(54) Information terminal and data transfer method for information terminal

(75) Inventor: Hiroshi Sukegawa, Nerima-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/086,413

(22) Filed: Mar. 23, 2005

(30) Foreign Application Priority Data
Mar. 23, 2004 (JP) 2004-085244

(51) Int. Cl. G06F 13/12

(52) U.S. Cl. 710/62

(57) ABSTRACT

An information terminal includes a data transfer information memory from which reading out of data transfer information can be facilitated by an access process implemented by a first transfer protocol from an external computer, a data memory to which writing of data and from which reading out data can be facilitated by an access process implemented by a second transfer protocol different from the first transfer protocol, and a file manager configured to read out data from the data memory by the second transfer protocol after communicating with the computer by the first transfer protocol, and to transfer the data to the computer by the second transfer protocol.

### CROSS REFERENCE TO RELATED APPLICATION AND INCORPORATION BY REFERENCE

This application is based upon and claims the benefit of priority from prior Japanese Patent Application No. P2004-085244, filed on Mar. 23, 2004, and is related to prior Japanese Patent Application No. P2005-67800, filed on Mar. 10, 2005; the entire contents of both of which are incorporated by reference herein.

### BACKGROUND OF THE INVENTION

1. Field of the Invention

The present invention relates to an information terminal capable of transferring data to a computer by using different types of transfer protocols, and to a data transfer method for the information terminal.

2. Description of the Related Art

An information terminal provides data transfer by general transfer protocol with a personal computer (PC) by using plug and play environment. It is easy for a user to a construct connection environment by using the general transfer protocol. On the other hand, the general transfer protocol is not able to achieve ideal data transfer efficiency for application equipment.

Non-general (specific) transfer protocol is able to achieve the ideal data transfer efficiency for application equipments. However, It is difficult for a user to construct the connection environment using the non-general transfer protocol.

An information mediating system having a protocol converter to convert protocols such as from among a world wide web (WWW) server, a network news transfer protocol (NNTP), and a hyper text transfer protocol (HTTP), or between an internet message access protocol (IMAP) and the HTTP, has been proposed (refer to, for example, Jpn. Pat. Appln. KOKAI Publication No. 2002-101149). With respect to the information mediation system, it is possible for terminals to perform news browsing and e-mail transmission by browsing a page generated by the WWW server.

### SUMMARY OF THE INVENTION

An aspect of the present invention inheres in an information terminal encompassing a data transfer information memory from which reading out of data transfer information can be facilitated by an access process implemented by a first transfer protocol from an external computer, a data memory to which writing of data and from which reading out data can be facilitated by an access process implemented by a second transfer protocol different from the first transfer protocol, and a file manager configured to read out data from the data memory by the second transfer protocol after communicating with the computer by the first transfer protocol, and to transfer the data to the computer by the second transfer protocol.

Another aspect of the present invention inheres in an information terminal encompassing an interface configured to connect to a external computer, a data transfer information memory connected to the interface and from which reading out of data transfer information can be facilitated by an access process implemented by a first transfer protocol from an external computer, a data memory connected to the interface and to which writing of data and from which reading out data can be facilitated by an access process implemented by a second transfer protocol different from the first transfer protocol, and a file manager connected to the interface and configured to read out data from the data memory, and to transfer the data to the computer by the second transfer protocol.

Still another aspect of the present invention inheres in a data transfer method for an information terminal encompassing, detecting an access process implemented by a first transfer protocol from an external computer, transferring data transfer information read out by the general transfer protocol from a data transfer information memory, adding a non-general data transfer environment different from a general data transfer environment of the computer, and permitting the computer to write and read out data of a data memory when an access process implemented by the computer is the non-general transfer protocol.

### BRIEF DESCRIPTION OF THE DRAWINGS

FIG. 1 is a block diagram showing an information terminal according to a first embodiment of the present invention.

FIG. 2 is a block diagram showing the information terminal according to the first embodiment.

FIG. 3 is a block diagram showing data hierarchy between the information terminal and a computer according to the first embodiment.

FIG. 4 is a flow chart showing an operation of the information terminal according to the first embodiment.

FIG. 5 is a block diagram showing a memory device used for the information terminal according to the first embodiment.

FIG. 6 is a block diagram showing an information terminal and a computer according to a second embodiment of the present invention.

FIG. 7 is a flow chart showing an operation of the information terminal according to the second embodiment.

FIG. 8 is a block diagram showing a universal serial bus (USB) memory according to a third embodiment of the present invention.

FIG. 9 is a schematic diagram for explaining a data transfer application program according to the third embodiment.

FIG. 10 is a schematic diagram of a comparative example for explaining the data transfer application program according to the third embodiment.

FIG. 11 is a flow chart showing a process of the data transfer application program according to the third embodiment.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and description of the same or similar parts and elements will be omitted or simplified. In the following descriptions, numerous specific details are set forth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention with unnecessary detail. In the following description, the words “connect” or “connected” define a state in which first and second elements are electrically connected to each other without regard to whether or not there is a physical connection between the elements.

### First Embodiment

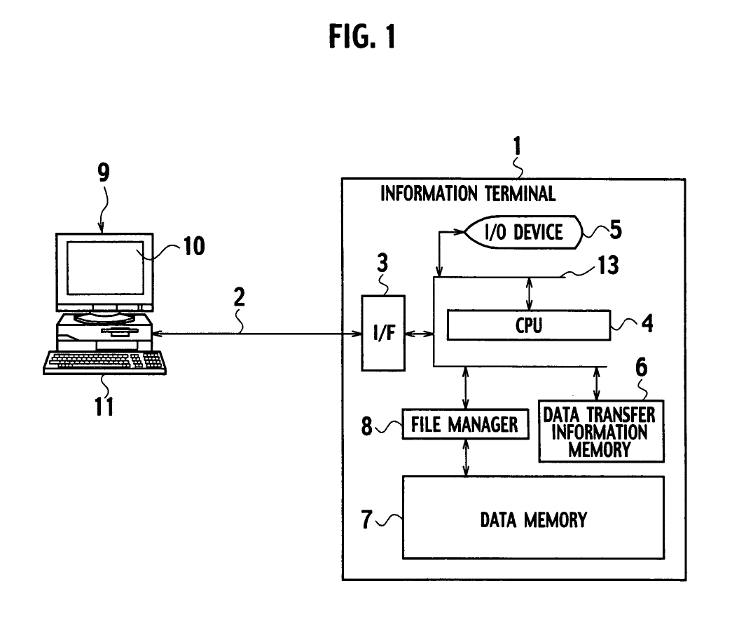

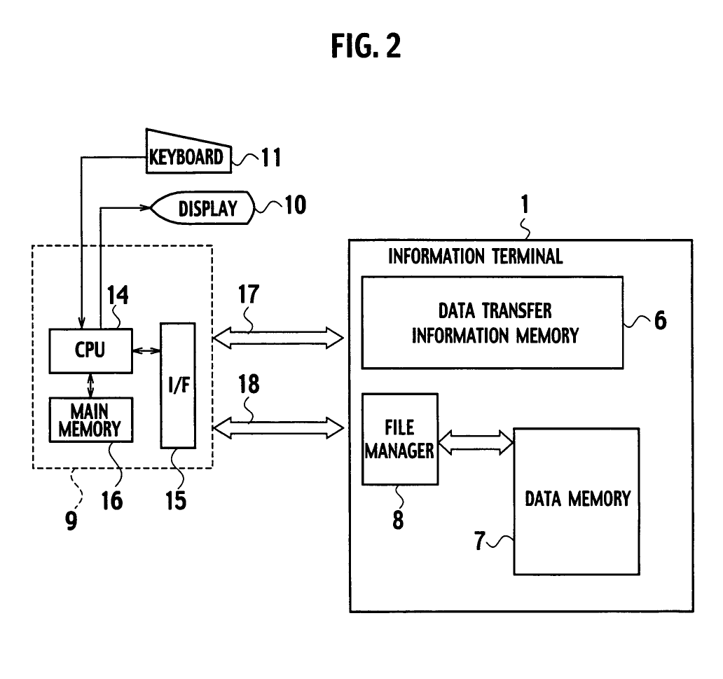

As shown in FIG. 1 and FIG. 2, an information terminal 1 according to a first embodiment of the present invention includes a data transfer information memory 6 from which reading out of data transfer information can be facilitated by an access process implemented by a first transfer protocol from an external computer 9, a data memory 7 to which writing of data and from which reading out data can be facilitated by an access process implemented by a second transfer protocol different from the first transfer protocol, and a file manager 8 configured to read out data from the data memory 7 by the second transfer protocol after communicating with the computer 9 by the first transfer protocol, and to transfer the data to the computer 9 by the second transfer protocol.

The information terminal 1 includes an interface (I/F) 3 configured to connect to the computer 9, the data transfer information memory 6 connected to the I/F 3 and from which reading out of data transfer information can be facilitated by an access process implemented by the first transfer protocol from the computer 9, a data memory 7 connected to the I/F 3 and to which writing of data and from which reading out data can be facilitated by an access process implemented by the second transfer protocol, and a file manager 8 connected to the I/F 3 and configured to read out data from the data memory 7, and to transfer the data to the computer 9 by the second transfer protocol.

For instance, the first transfer protocol is a general transfer protocol, and the second transfer protocol is a non-general transfer protocol. A portable music player or portable information equipment can be used as the information terminal 1.

The data transfer information memory 6 is included in the information terminal 1. The data transfer information memory 6 is accessed from the PC 9 by use of file system corresponding to the general transfer protocol. A sixteen or thirty-two bit file allocation table (FAT) file system can be used as the file system.

For instance, a mass-storage-class transfer protocol of a USB card or a PC card AT attachment (ATA) transfer protocol of the PC 9 can be used as the general transfer protocol. The general transfer protocol is able to access the data transfer information memory 6 via the I/F 3 and the bus 13 of the information terminal 1.

In the first embodiment, when the PC 9 and the information terminal 1 are connected to each other by the cable 2, communication therebetween is started by the general transfer protocol. The information terminal 1 adds the data transfer environment corresponding to the non-general transfer protocol to the PC 9 automatically. As a result, the information terminal 1 transacts of the data transfer by using the non-general transfer protocol which is exclusive and effective for the information terminal 1.

Since the PC 9 normally has a data transfer environment of the general transfer protocol, it is easy for a user to achieve a connection environment such as the plug and play environment. That is, it is possible for a user to achieve the connection environment by only connecting the cable 2 between the information terminal 1 and the PC 9 without utilizing the display 10 and the keyboard 11 of the PC 9.

Therefore, it is possible for a user to achieve the connection environment without installing a transfer application from mediums such as a compact disk or internet.

The PC 9 performs reading and writing to the data memory 7 via the cable, the I/F 3, and the bus 13 by use of the non-general transfer protocol which optimizes the transaction of the data transfer.

For achieving operability of the plug and play environment, contents of the data memory 7 of the information terminal 1 can be recognized by PC 9, similar to the connection environment of the general transfer protocol.

For instance, a data transfer application program for setting the connection environment of the non-general transfer protocol to the PC 9 is previously stored in the data transfer information memory 6. The data transfer application program is automatically started at the PC 9. As a result, it is possible to achieve effective data transfer between the information terminal 1 and the PC 9 by the non-general transfer protocol.

The information terminal 1 transfers data by file hierarchy to the PC 9. Therefore, it is possible to achieve the most effective data transfer protocol for the information terminal 1.

With respect to the general transfer protocol, the information terminal 1 transfers data to the PC 9 by sector (for instance, 512 bytes) of data memory 7 in response to user operations of an input/output (I/O) device 5. With respect to the non-general transfer protocol, it is possible to transfer data of every kind that is larger than sector (for instance, 1 M byte) at once.

A button operation device or a touch panel can be used as the input device. A liquid crystal display (LCD) or an electro luminescence (EL) display can be used as the output device.

The information terminal 1 requires various types of transactions for the data transfer to the PC 9. As a result, it is possible to achieve the most effective data transfer transaction for the information terminal 1.

For instance, information terminal 1 transmits data transfer restrictions of information terminal 1 such as a file number of the data memory 7, and a limitation of directory hierarchy. As a result, an operating system (OS) of the PC 9 executes data transfer transactions optimized for the information terminal 1.

The data transfer information memory 6 may have previously stored information exchange protocols related to intellectual property such as a copyright and a patent right of non-general transfer protocol.

As shown in FIG. 2, the information terminal 1 includes the data transfer information memory 6 having a 1 M byte memory area accessed by the general transfer protocol, the data memory 7 having a 512 M byte memory area, and the file manager 8 configured to manage data files in the data memory 7.

The data transfer information memory 6 previously stores a data transfer application program for the non-general data transfer, and a plurality of files (for instance, “ini” file as driver software and an environment setting file) for adding the non-general data transfer environment to the PC 9.

The PC 9 accesses the data transfer information memory 6 as a mass-storage-class of USB specifications.

The OS of the PC 9 recognizes the data transfer information memory 6 as an external memory medium, by a connection of the mass-storage-class, and executes the data transfer application program. Therefore, it is possible for a user to browse the driver software and an icon of the environment-setting file by viewing the display 10.

The non-general data transfer driver software and the environment setting file of the non-general data transfer may be transferred to main memory 16 via the I/F 15 and the CPU 14.

In the general transfer protocol 17, the PC 9 accesses files stored in the 1 M byte area in the data transfer information memory 6 of the information terminal 1. The data transfer application program is started automatically. The system setting of the PC 9 is automatically added by referring to the driver software and the environment-setting file.

The PC 9 switches the transfer protocol from the general transfer protocol 17 to the non-general transfer protocol 18 in response to the user operation of the keyboard 11. As a result, it is possible to access data memory 7 by utilizing the non-general transfer protocol 18, and to effectively execute I/O processing of the data files via the file manager 8.

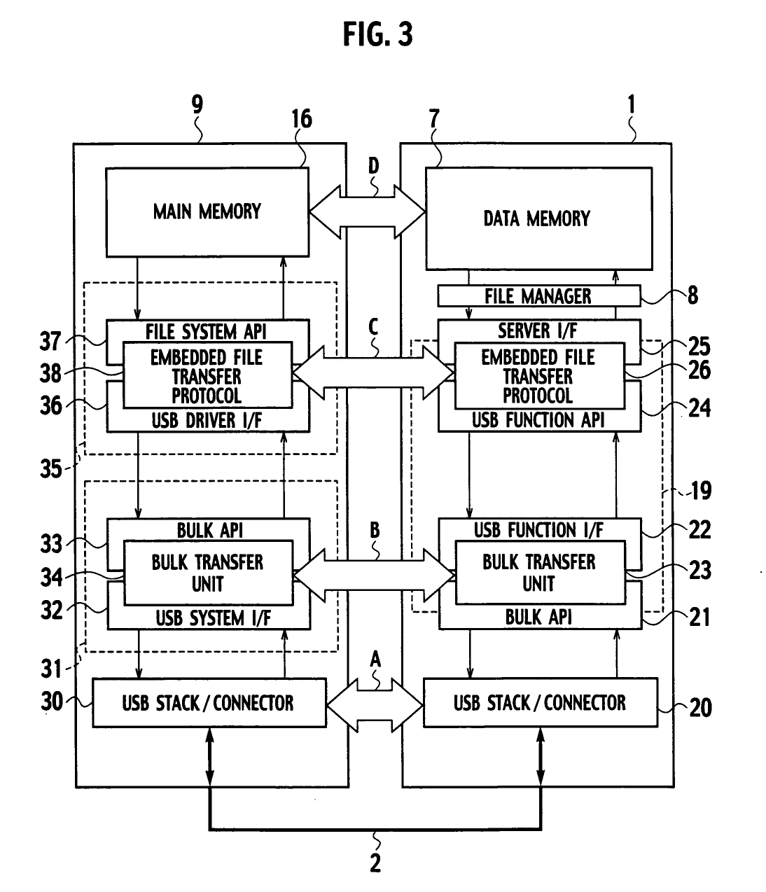

The non-general data transfer between the PC 9 and the information terminal 1 is executed as the file hierarchy as shown in FIG. 3.

The PC 9 includes the main memory 16 configured to store a client application, a USB file memory driver 35 connected to the main memory 16, a USB bulk driver 31 connected to the USB file memory driver 35, and a USB stack and connector 30 connected to the USB bulk driver 31.

The information terminal 1 includes the data memory 7 configured to store the server application, a USB file memory I/F 19 connected to the data memory 7 via the file manager 8, and a USB stack and connector 20 connected to the USB file memory I/F 19.

The PC 9 communicates with the information terminal 1 via the cable 2. Physical files are transferred to the PC 9 from the information terminal 1 by use of the existing hardware of the USB.

For instance, data transfer “A” of a physical file related to the USB stack and connector 20 executes the general transfer protocol transaction.

Similarly, files of the bulk application program interface (API) 21 and the USB function I/F 22 are transferred by using the general transfer protocol as physical files related to the bulk transfer unit 23 which is one hierarchy of the USB file memory I/F 19, and transactions of data transfer “B” are executed.

Files of the USB function API 24 and the server I/F 25 are transferred by using the general transfer protocol as physical files related to non-general embedded file transfer protocol 26 which is another hierarchy of the USB file memory I/F 19, and transactions of data transfer “C” are executed.

The data memory 7 stores a server application capable of executing transactions of data transfer “D” to the main memory 16 of the PC 9 by the file hierarchy. In this case, the non-general transfer protocol is executed at the USB stack and connector 30 via the file manager 8, USB file memory I/F 19, and USB stack and connector 20.

The PC 9 adds a driver corresponding to the data transfer hierarchy “B” to the USB bulk driver 31. For instance, the driver is added to the USB system I/F 32 and the bulk API 33 of the bulk transfer unit 34.

Similarly, the PC 9 adds a driver corresponding to the data transfer hierarchy “C” to the USB file memory driver 35. For instance, the driver 35 is added to the USB driver I/F 36 and the file system API 37 as physical files related to the embedded file transfer protocol 38.

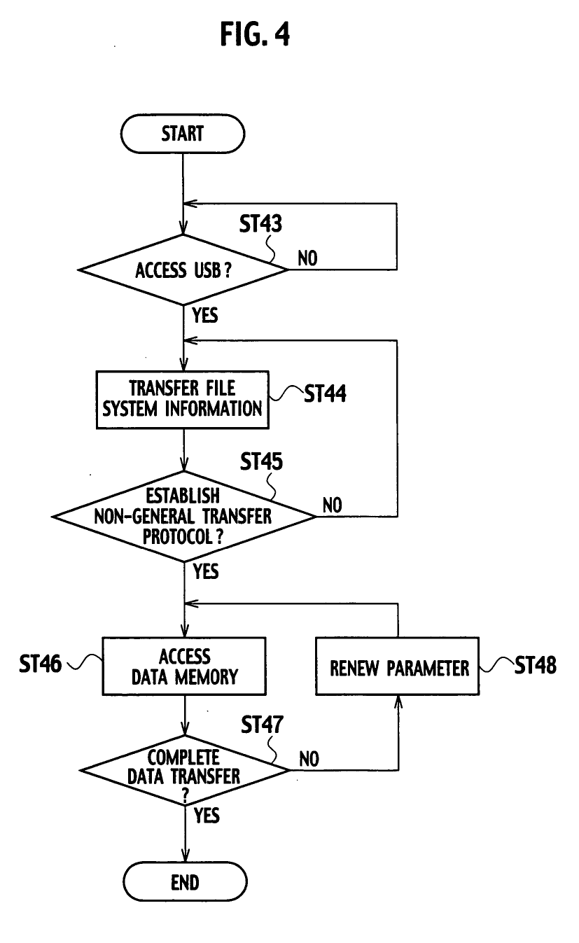

An operation of the information terminal 1 according to the first embodiment will be described with reference to FIG. 1 and FIG. 4. When a connection of the cable 2 is detected, the communication between the information terminal 1 and the PC 9 is started.

The I/F 3 shown in FIG. 1 repeats step ST43 until the connection of the cable 2 is determined as a USB access. When the connection of the cable 2 is determined as a USB access, the procedure goes to step ST44.

In step ST44, the PC 9 executes the data transfer application program stored in the data transfer information memory 6, and receives the driver software and the environment setting file stored in the data transfer information memory 6 via the bus 13 and the I/F 3 by the general transfer protocol.

The data transfer application program executed at the information terminal 1 automatically selects a driver corresponding to the OS of the PC 9. For instance, since a driver setting application that is a part of the data transfer application program refers to the version of the OS, it is possible to select the driver file.

The PC 9 shows icons of the driver software and the environment-setting file stored in data transfer information memory 6 on the display 10 for the user. In the general transfer protocol, it is possible to browse the files stored in the data memory 7 when the icons are displayed.

In step ST45, the PC 9 starts a file management program when the user transfers files stored in data memory 7 to the PC 9 for instance. When the keyboard operation is started, the general transfer protocol is switched to the non-general transfer protocol. The information terminal 1 determines whether the non-general transfer protocol is established.

When it is determined that the non-general transfer protocol is established, the procedure goes to step ST46. When it is determined that the non-general transfer protocol is not established, the procedure returns to step ST44. In this case, the information terminal 1 re-transfers the driver software and the environment-setting file to the PC 9.

In step ST46, the PC 9 accesses the data memory 7 of the information terminal 1, and executes data transfer by the non-general transfer protocol. In step ST47, the information terminal 1 determines whether the data transfer of files stored in the data memory 7 is completed.

When the data transfer of files stored in the data memory 7 is not completed, the procedure goes to step ST48. In step ST48, parameters of non-general transfer protocol, such as address information of the file manager 8, are renewed. Then, the procedure returns to step ST46, and the data transfer by the non-general transfer protocol is continued.

When the data transfer of files stored in the data memory 7 is completed in step ST47, the data transfer process is completed.

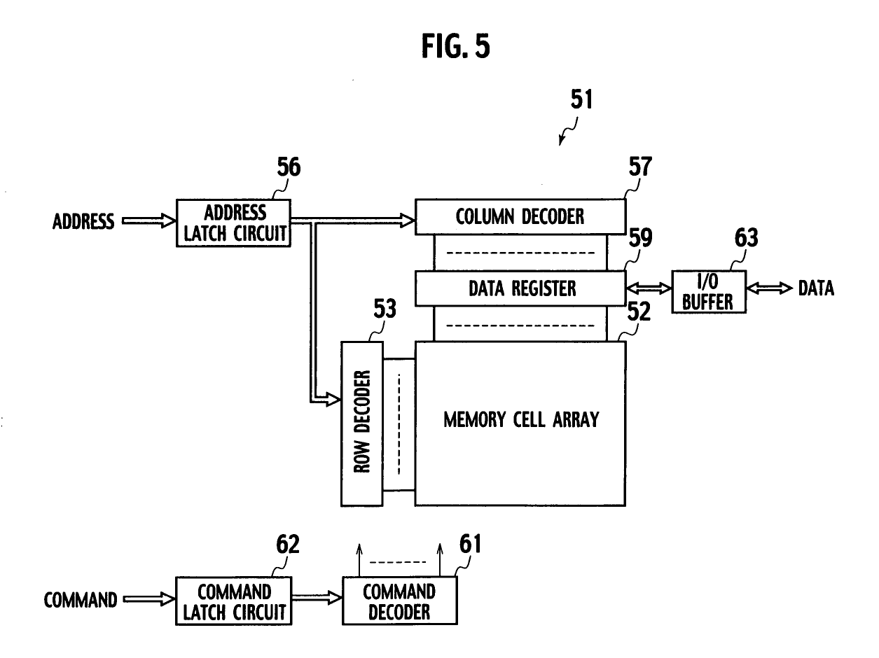

Although the data transfer information memory 6 and the data memory 7 are included in the memory device 51 (flash memory) shown in FIG. 5, the data transfer information memory 6 may be provided outside the memory device 51.

For instance, data reading-memory such as a mask read only memory (ROM) or an erasable programmable read only memory (EPROM) can be utilized as the data transfer information memory 6. In this case, it is possible to decrease the manufacturing cost of the information terminal 1 since the circuit scale of the data transfer information memory 6 can be decreased.

As shown in FIG. 5, the memory device 51 includes a memory cell array 52 having a plurality of memory cell transistors arranged in a matrix-shape. Each memory cell transistor has an electrical charge storage layer capable of independently controlling the electrical charge storage state.

It is possible to erase large files stored in the data memory 7 in a single operation since the memory device 51 is a flash memory having a storage function requiring a block erase. In this case, the erase process can be completed in a short time since it is possible to erase on a large scale compared to general transfer protocol erasing every sector.

For instance, it is possible to set the erase block size of the flash memory to more than 128 K bytes, and to execute the non-general transfer protocol. However, the erase block size is not limited to 128 K bytes.

In FIG. 5, the memory cell array 52 has a plurality of word lines, a plurality of selecting gate lines, and a plurality of bit lines. A plurality of memory cells are connected to the word lines and the bit lines. The memory cells are divided into a plurality of blocks. Data is erased in the block unit.

A data register 59 having a plurality of latch circuits and a row decoder 53 configured to selectively drive word lines and selecting gate lines is connected to the memory cell array 52.

In reading out data, the data register 59 temporarily stores data read out from memory cell array 52 via the bit line. In writing data to the memory cell array 52, the data register 59 temporarily stores data, and supplies the data to the memory cell array 52.

An I/O buffer 63 and a column decoder 57 are connected to the data register 59. In reading out data, data selected by the column decoder 57 in read data stored in the data register 59 is read out via the I/O buffer 63. In writing data, write data supplied by an external memory via the I/O buffer 63 is stored in latch circuits of the data register 59 selected by the column decoder 57.

In reading out and writing data, the row decoder 53 selectively drives word lines and selecting gate lines in the memory cell array 52 so that memory cells of a page in the memory cell array 52 are selected at the same time.

The address latch circuit 56 latches the address input, supplies the row address to the row decoder 53, and supplies the column address to the column decoder 57.

The command latch circuit 62 receives the command input. The command decoder 61 is connected to the command latch circuit 62. The command decoder 61 decodes the command, and generates various control signals. The data register 59, the row decoder 53, the I/O buffer 63, the column decoder 57, and the address latch circuit 56 are controlled based on the control signals generated by the command decoder 61.

The memory device 51 further includes a voltage generator (not illustrated) to generate a high and mid-range voltage for supplying the row decoder 53 and the memory cell array 52.

As described above, with the information terminal 1 and method for transferring data for the information terminal 1 according to the first embodiment of the present invention, it is possible to provide the non-general data transfer environment by the plug and play environment.

Since it is possible to add the non-general data transfer environment via the mass-storage-class of devices that use a general transfer protocol of USB standards, it is possible to connect the information terminal 1 to various PCs.

Furthermore, since the non-general transfer protocol is the file hierarchy level transfer protocol, effective data transfer corresponding to the performance of the application equipment can be achieved.

The memory device 51 can be utilized as a memory device capable of utilizing the non-general transfer protocol. Especially, a flash memory with a large erase block size can be utilized as a memory device capable of utilizing the non-general transfer protocol.

A flash memory having a data writing unit of more than 512 K bytes is capable of utilizing the non-general transfer protocol.

In the aforementioned description, the information terminal 1 has the I/O device 5. However, the I/O device 5 may be omitted. For instance, a USB memory can be utilized as information terminal, which does not have the I/O device 5.

### Second Embodiment

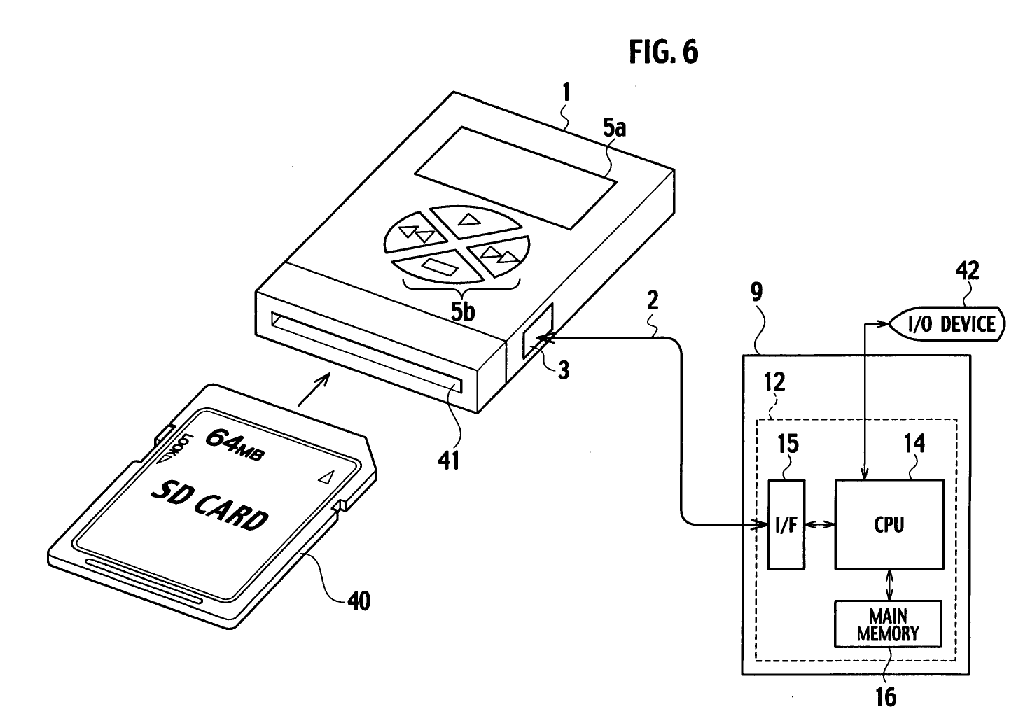

As shown in FIG. 6, an information terminal 1 according to a second embodiment of the present invention includes an I/F 3a, display 5a as the output device, an input device 5b for user operation, and a card slot 41. Repeated descriptions for the arrangement according to the second embodiment which are the same as the first embodiment are omitted.

A memory card 40 is inserted in the card slot 41. A secure digital (SD™) card can be utilized as the memory card 40, for instance. In the following descriptions, an example in which the SD card is used as the memory card 40 will be explained.

The memory card 40 includes the data transfer information memory 6 shown in FIG. 1, the data memory 7 shown in FIG. 1, and the file manager 8 shown in FIG. 1, similar to the first embodiment.

The format of the data transfer information memory 6 and the data memory 7 is compatible with the address of a flash memory in the memory card 40.

The data transfer information memory 6 stores the data transfer application program for executing the non-general data transfer, and files for the non-general data transfer environment such as the driver software and the environment setting file.

The PC 9 accesses the data transfer information memory 6 by the general transfer protocol via the cable 2, similar to the first embodiment.

It is possible to provide information terminal 1 capable of operating with high speed, as compared to the general transfer protocol since the PC 9 can access the data memory 7 by the non-general data transfer environment.

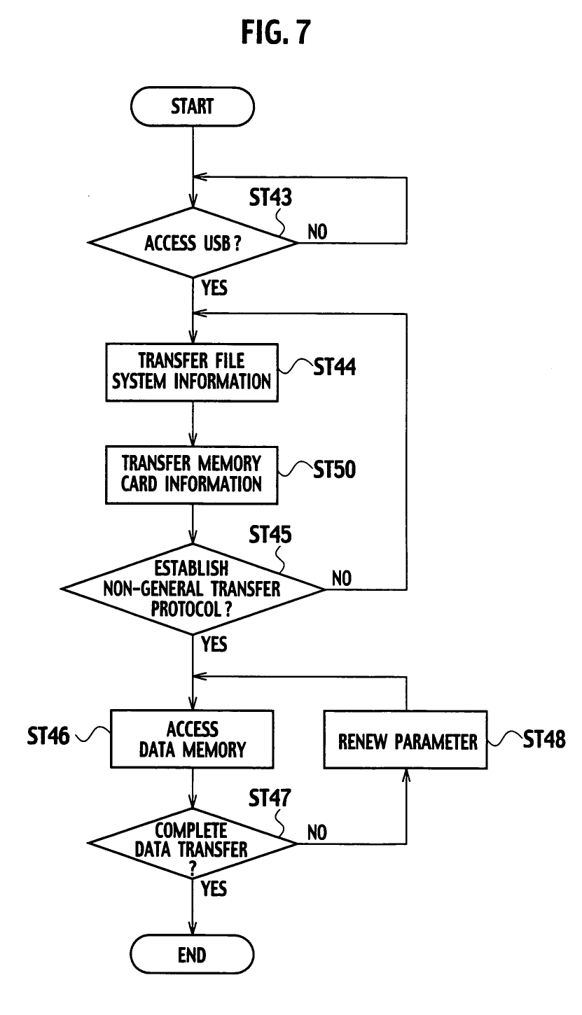

An operation of the information terminal 1 according to the second embodiment will be described with reference to FIG. 1, FIG. 6, and FIG. 7. When the I/F 3 detects a connection of the cable 2, the communication between the information terminal 1 and the PC 9 is started.

The I/F 3 shown in FIG. 1 repeats step ST43 until the connection of the cable 2 is determined as a USB access. When the connection of the cable 2 is determined as a USB access, the procedure goes to step ST44.

In step ST44, the PC 9 executes the data transfer application program stored in the data transfer information memory 6, and receives the driver software and the environment setting file stored in the data transfer information memory 6 via the bus 13 and the I/F 3, by the general transfer protocol.

The data transfer application program executed at the information terminal 1 automatically selects a driver corresponding to the OS of the PC 9. For instance, since a driver setting application that is a part of the data transfer application program refers to the version of the OS, it is possible to select the driver file.

The PC 9 shows icons of the driver software and the environment-setting file stored in data transfer information memory 6 on the display 10 for the user. In the general transfer protocol, it is possible to browse the files stored in the data memory 7 when the icons are displayed.

In step ST50, the memory card 40 transmits memory card information to the PC 9. The memory card information is stored in the data transfer information memory 6.

The data transfer information memory 6 stores card identification (CID) information. For instance, the CID having 128 bits includes a maker ID having eight bits, an OEM/application ID having 16 bits, a product code having 40 bits, a product revised edition code having eight bits, a production number having 32 bits, a reservation field having four bits, a production date code having 12 bits, a Cyclic Redundancy Check (CRC) check sum having seven bits, and a field fixed to a logic value “1”.

The production number includes ID information of the non-general data transfer protocol. However, the ID information may be included in other codes or fields.

In step ST45, the PC 9 starts a file management program when the user transfers files stored in data memory 7 to the PC 9. When the keyboard operation to the keyboard 11 is started, the general transfer protocol is switched to the non-general transfer protocol. The information terminal 1 determines whether the non-general transfer protocol is established.

When it is determined that the non-general transfer protocol is established, the procedure goes to step ST46. When it is determined that the non-general transfer protocol is not established, the procedure returns to step ST44. In this case, the information terminal 1 re-transfers the driver software and the environment-setting file to the PC 9.

In step ST46, the PC 9 accesses the data memory 7 of the information terminal 1, and executes data transfer by the non-general transfer protocol. In step ST47, the information terminal 1 determines whether the data transfer of files stored in the data memory 7 is completed.

When the data transfer of files stored in the data memory 7 is not completed, the procedure goes to step ST48. In step ST48, parameters of non-general transfer protocol such as address information of the file manager 8, are renewed. Then, the procedure returns to step ST46, and the data transfer by the non-general transfer protocol is continued.

When the data transfer of files stored in the data memory 7 is completed in step ST47, the data transfer process is completed.

Although the data transfer information memory 6 and the data memory 7 are included in the memory device 51 (flash memory) shown in FIG. 5, various types of memory can be utilized instead of the flash memory.

As described above, regarding the information terminal 1 and the data transfer method for the information terminal 1 according to the second embodiment of the present invention, it is possible to use application equipments capable of attaching and removing the flash memory or a card reader/writer.

### Third Embodiment

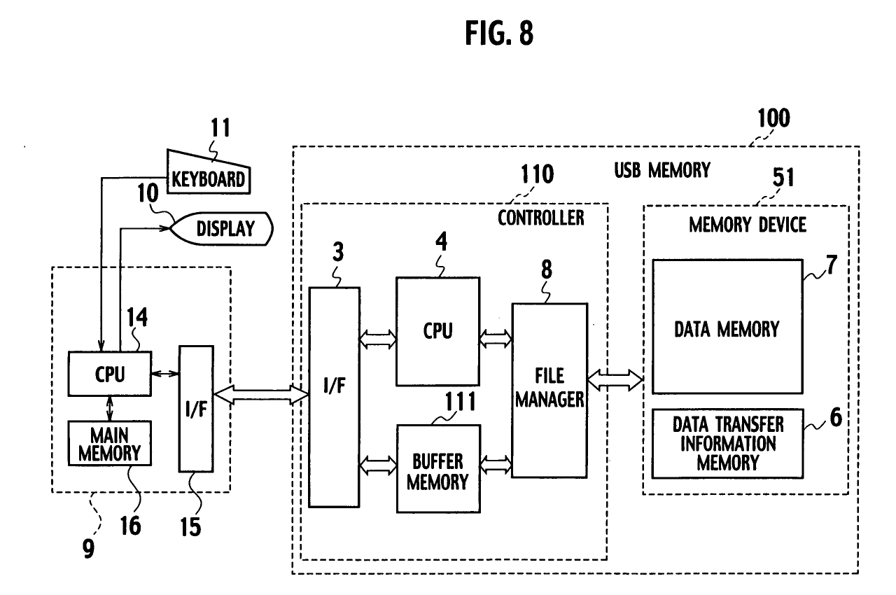

As shown in FIG. 8, with respect to a third embodiment of the present invention, a USB memory 100 is utilized as the information terminal 1 shown in FIG. 1 and FIG. 2, for instance. The USB memory 100 shown in FIG. 8 includes a controller 110 and a memory device 51. A NAND flash memory can be utilized as the memory device 51, similar to the first and second embodiments.

As shown in FIG. 6, the I/F 3, CPU 4, and file manager 8 are provided in the controller 110. The data transfer information memory 6 and the data memory 7 are provided in the memory device 51. Furthermore, controller 110 includes a buffer memory 111. A static random access memory (SRAM) can be used as the buffer memory 111, for instance.

An I/F in conformity with the USB standards is provided as the I/F 3. The I/F 3 is directly connected to the PC 9 without using the cable 2 shown in FIG. 1. The USB memory 100 does not include I/O device 5 shown in FIG. 1. Other arrangements are similar to FIG. 1 and FIG. 2.

The data transfer application program for setting the non-general transfer protocol connection environment to the PC 9 is previously stored in the data transfer information memory 6. The data transfer application program is installed in the main memory 16 of the PC 9 by using the general transfer protocol. The CPU 14 of the PC 9 executes the data transfer application program, and transfers the file data to the USB memory 100 by using the non-general transfer protocol.

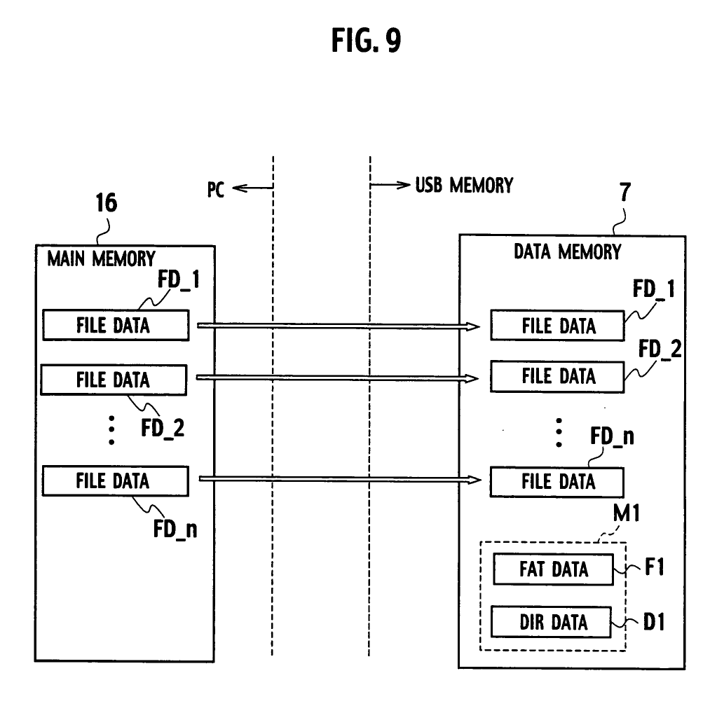

The CPU 14 of the PC 9 executes the data transfer application program, and performs a file transfer shown in FIG. 9. As shown in FIG. 9, first to n-th file data FD_1 to FD_n, and management information M1 of the first to n-th file data FD_1 to FD_n are written into the data memory 7 individually (n; equal to or more than 2). The management information M1 includes FAT data F1 and directory (DIR) data D1.

It is possible to execute the transfer of the first to n-th file data FD_1 to FD_n as a single task, by the data transfer application program. The data transfer process of the data transfer application program will be described later.

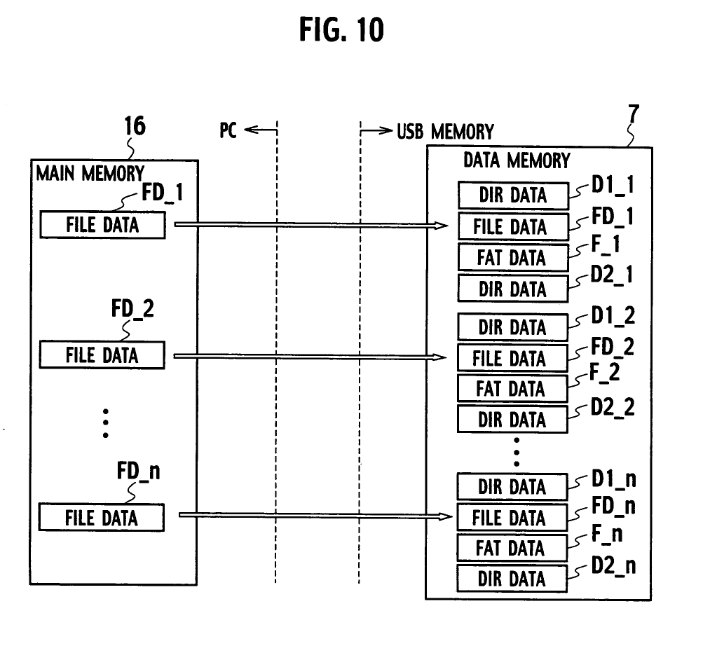

On the other hand, when the CPU 14 of the PC 9 individually executes the transfer of the first to n-th file data FD_1 to FD_n, a renewal of the management information is required for each transfer of the data file as shown in FIG. 10.

In FIG. 10, DIR data D1_1 and D2_1, and FAT data F_1 are added to the file data FD_1 in transferring the file data FD_1. Similarly, DIR data D1_n and D2_n, and FAT data F_n are added to the file data FD_n in transferring the file data FD_n. Furthermore, the transfer of the first to n-th file data FD_1 to FD_n is unrelated to the logical block address (LBA) order of the USB memory 100.

As a result, transfer of data needing a long time for the transfer can be occurred. Especially, when the data size of each data file is small, the writing burden of the management information (FAT data and DIR data) increases.

Therefore, it is possible to decrease a time needed for the data transfer by installing the data transfer application program in the PC 9 from the USB memory 100 and executing the transfer technique shown in FIG. 9.

Regarding the NAND flash memory shown in FIG. 8, writing or reading is performed to several kilobits of continuous address at once. Accordingly, the buffer memory 111 is utilized when the writing or reading is performed for a small size of data or non-continuous addresses.

The buffer memory 111 is able to operate at a higher speed than the NAND flash memory. The CPU 4 utilizes the buffer memory 111 to increase data transfer efficiency when an operation speed greater than the maximum speed of the NAND flash memory is required.

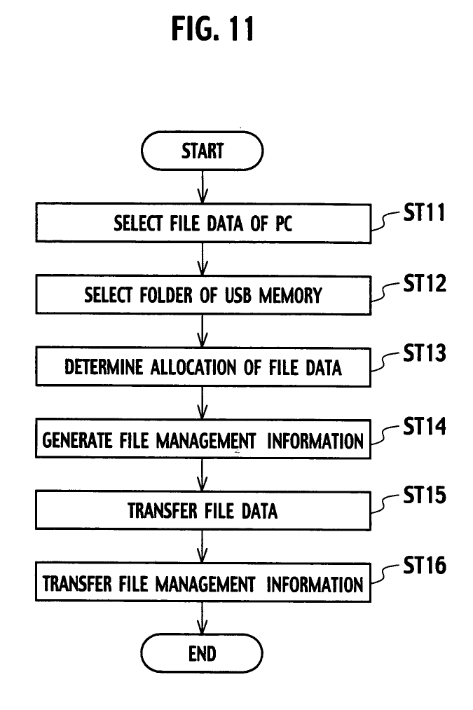

A procedure of the data transfer application program according to the third embodiment will be described with reference to FIG. 8, FIG. 9, and FIG. 11.

In step ST11 of FIG. 11, a data file to be transferred (copied) to the USB memory 100 is selected by a user operation of the keyboard 11 shown in FIG. 8. Here, the non-general data transfer application is started when a plurality of files are selected at the same time. When the non-general data transfer application is started, the CPU 14 of the PC 9 executes the procedure by the data transfer application program.

In step ST12, a folder in the USB memory 100 for receiving the transferred files is selected by user operation of the keyboard 11.

In step ST13, the CPU 14 of the PC 9 analyzes the FAT file system in the data memory 7, and determines the cluster allocation of the file data to be transferred in the data memory 7, as shown in FIG. 9.

In step ST14, the CPU 14 of the PC 9 generates the management information M1 of the file data to be transferred, as shown in FIG. 9.

In step ST15, the CPU 14 of the PC 9 reads out the first to n-th file data FD_1 to FD_n from the main memory 16, and transfers the first to n-th file data FD_1 to FD_n to the data memory 7. The first to n-th file data FD_1 to FD_n are written to the data memory 7 in LBA incremental order.

In step ST16, the CPU 14 of the PC 9 transfers the management information M1 generated in step ST14 to the data memory 7.

As described above, according to the third embodiment, the PC 9 can effectively transfer data to the USB memory 100 by installing the data transfer application program in the PC 9 from the USB memory 100. Therefore, it is possible to easily provide the USB memory 100 that is capable of arranging data transfer connection environment of the non-general transfer protocol.

### Other Embodiments

Various modifications will become possible for those skilled in the art after receiving the teachings of the present disclosure without departing from the scope thereof.

In the third embodiment, description was given of an example in which the USB memory 100 is utilized. However, a PC card can be utilized instead of the USB memory 100.

In the first to third embodiments, NAND flash memory is utilized as the memory device. However, a ferroelectric random access memory (FeRAM) or a magnetoresistive random access memory (MRAM) can be utilized as the memory device instead of the NAND flash memory.

1. An information terminal comprising:
a data transfer information memory from which reading out of data transfer information can be facilitated by an access process implemented by a first transfer protocol from an external computer;
a data memory to which writing of data and from which reading out data can be facilitated by an access process implemented by a second transfer protocol different from the first transfer protocol; and
a file manager configured to read out data from the data memory by the second transfer protocol after communicating with the computer by the first transfer protocol, and to transfer the data to the computer by the second transfer protocol.

2. The information terminal of claim 1, wherein the first transfer protocol is a general transfer protocol, and the second transfer protocol is a non-general transfer protocol.

3. The information terminal of claim 1, wherein the data transfer information memory and the data memory are provided in a NAND flash memory.

4. The information terminal of claim 1, further comprising a universal serial bus interface configured to connect to the computer.

5. The information terminal of claim 2, wherein the file manager detects access of the non-general transfer protocol from the computer, and writes and reads data to the data memory by utilizing the non-general transfer protocol.

6. The information terminal of claim 2, wherein the file manager transfers data by use of the non-general transfer protocol, in larger data unit size than the general transfer protocol.

7. The information terminal of claim 2, wherein the file manager transfers data by file hierarchy by use of the non-general transfer protocol.

8. The information terminal of claim 2, wherein the data transfer information memory transfers data transfer information to the computer by using the general transfer protocol, and stores a data transfer application program for adding a non-general data transfer environment different from a general data transfer environment of the computer.

9. The information terminal of claim 8, wherein the computer executes a transfer of a plurality of file data as a single task, by the data transfer application program.

10. The information terminal of claim 8, wherein the computer individually transfers a plurality of file data and management information of the file data, by the data transfer application program.

11. An information terminal comprising:
an interface configured to connect to a external computer;
a data transfer information memory connected to the interface and from which reading out of data transfer information can be facilitated by an access process implemented by a first transfer protocol from an external computer;
a data memory connected to the interface and to which writing of data and from which reading out data can be facilitated by an access process implemented by a second transfer protocol different from the first transfer protocol; and
a file manager connected to the interface and configured to read out data from the data memory, and to transfer the data to the computer by the second transfer protocol.

12. The information terminal of claim 11, wherein the first transfer protocol is a general transfer protocol, and the second transfer protocol is a non-general transfer protocol.

13. The information terminal of claim 11, wherein the data transfer information memory and the data memory are provided in a NAND flash memory.

14. The information terminal of claim 12, wherein the file manager detects access of the non-general transfer protocol from the computer, and writes and reads data to the data memory by utilizing the non-general transfer protocol.

15. The information terminal of claim 12, wherein the file manager transfers data by use of the non-general transfer protocol, in larger data unit size than the general transfer protocol.

16. The information terminal of claim 12, wherein the file manager transfers data by file hierarchy by use of the non-general transfer protocol.

17. The information terminal of claim 12, wherein the data transfer information memory transfers data transfer information to the computer by using the general transfer protocol, and stores a data transfer application program for adding a non-general data transfer environment different from a general data transfer environment of the computer.

18. The information terminal of claim 17, wherein the computer executes a transfer of a plurality of file data as a single task, by the data transfer application program.

19. The information terminal of claim 17, wherein the computer individually transfers a plurality of file data and management information of the file data, by the data transfer application program.

20. A data transfer method for an information terminal comprising:
detecting an access process implemented by a first transfer protocol from an external computer;
transferring data transfer information read out by the general transfer protocol from a data transfer information memory;
adding a non-general data transfer environment different from a general data transfer environment of the computer; and
permitting the computer to write and read out data of a data memory when an access process implemented by the computer is the non-general transfer protocol.
